(19) United States
(12) Patent Application Publication
(10) Pub. No.: US 2015/0319719 A1
(43) Pub. Date: Nov. 5, 2015

(54) APPARATUS AND METHOD FOR WCDMA RACH OPTIMIZATION

(71) Applicant: Nokia Corporation, Espoo (FI)

(72) Inventors: Ville Steudle, Turku (FI); Ladislav Kusnyer, Salo (FI); Harri Valio, Kammenniemi (FI)

(21) Appl. No.: 14/268,178

(22) Filed: May 2, 2014

(51) Int. Cl. H04W 52/48; H04W 74/08; H04W 24/02

(52) U.S. Cl. CPC H04W 52/48; H04W 24/02; H04W 74/0833

(57) ABSTRACT

According to an example embodiment of this application, a method may include transmitting at least one preamble with a predetermined power level to a network element; determining whether to retransmit the at least one preamble to the network element; if it is determined to retransmit, retransmitting the at least one preamble with a ramped down power level; and transmitting a message to the network element based on at least one of the predetermined power level and the ramped down power level.

### TECHNICAL FIELD

The present application relates generally to an apparatus and a method for wideband code division multiple access, WCDMA, random access channel, RACH, optimization.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application.

In wireless communications, different collections of communication protocols are available to provide different types of services and capabilities. Wideband code division multiple access, WCDMA, is one of such collection of wireless communication protocols developed for universal mobile telecommunications system, UMTS, and is specified by different releases of the standard by the 3^{rd} generation partnership project, 3GPP, in the area of mobile network technology. Other non-limiting example wireless communication protocols include global system for mobile, GSM, long term evolution, LTE, wireless local area network WLAN, and worldwide interoperability for microwave access, WiMAX, etc.

Random access channel, RACH, is used by user equipment, UE, for access to the network of WCDMA or some other protocols, normally when the UE does not have accurate uplink timing synchronization, or when the UE does not have any allocated uplink transmission resource.

### SUMMARY

Various aspects of examples of the invention are set out in the claims.

According to a first aspect of the present invention, there is provided a method comprising transmitting at least one preamble with a predetermined power level to a network element; determining whether to retransmit the at least one preamble to the network element; if it is determined to retransmit, retransmitting the at least one preamble with a ramped down power level; and transmitting a message to the network element based on at least one of the predetermined power level and the ramped down power level.

According to a second aspect of the present invention, there is provided an apparatus comprising at least one processor, and at least one memory including computer program code, wherein the at least one memory and the computer program code configured to, with the at least one processor, cause the apparatus at least to transmit at least one preamble with a predetermined power level to a network element; determine whether to retransmit the at least one preamble to the network element; if it is determined to retransmit, retransmit the at least one preamble with a ramped down power level; and transmit a message to the network element based on at least one of the predetermined power level and the ramped down power level.

According to a third aspect of the present invention, there is provided a computer program product comprising a computer-readable medium bearing computer program code embodied therein for use with a computer, the computer program code may include code for transmitting at least one preamble with a predetermined power level to a network element; determining whether to retransmit the at least one preamble to the network element; if it is determined to retransmit, retransmitting the at least one preamble with a ramped down power level; and transmitting a message to the network element based on at least one of the predetermined power level and the ramped down power level.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example wireless system in accordance with an example embodiment of the invention;

FIG. 2 illustrates a random access channel, RACH, operation in accordance with an example embodiment of the invention;

FIG. 3 illustrates an RACH operation in accordance with another example embodiment of the invention;

FIG. 4 illustrates an RACH operation in accordance with another example embodiment of the invention;

FIG. 5 illustrates an RACH operation in accordance with another example embodiment of the invention;

FIG. 6 illustrates an RACH operation in accordance with another example embodiment of the invention;

FIG. 7 illustrates a flow diagram of performing a random access procedure according to an example embodiment of the invention;

FIG. 8 illustrates a simplified block diagram of an example apparatus that is suitable for use in practicing various example embodiments of this invention.

### DETAILED DESCRIPTION

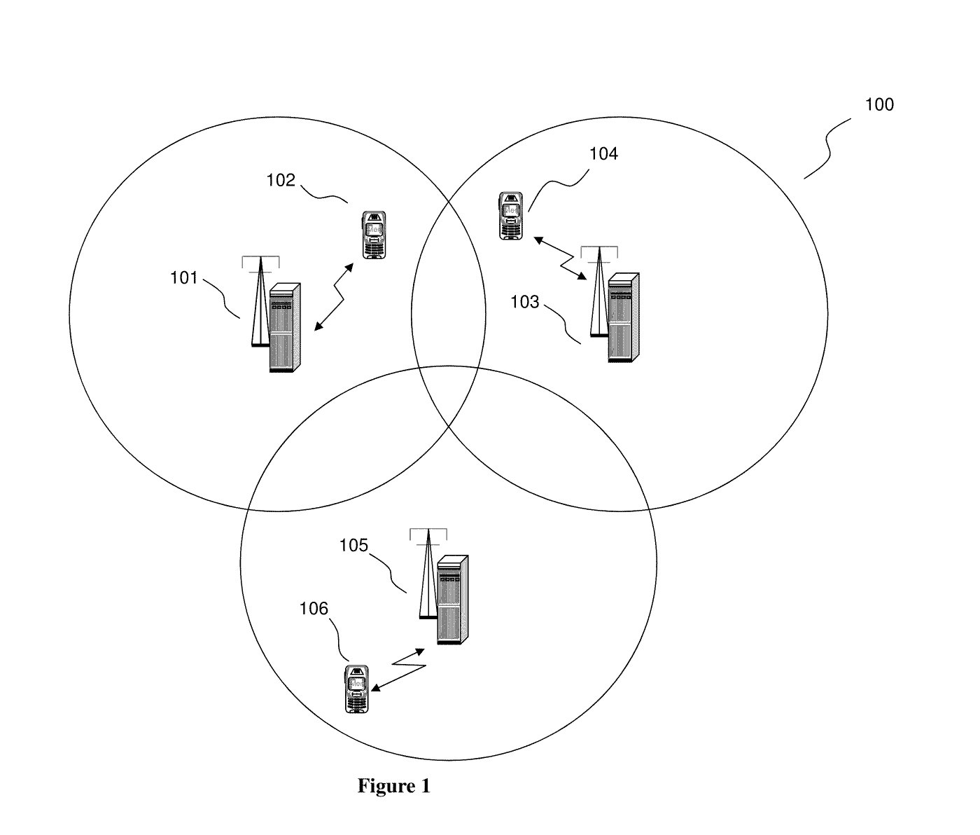

In the illustration of various embodiments below, 3^{rd} generation partnership project, 3GPP, wideband code division multiple access, WCDMA, will be used as the non-limiting example of the radio access technology. It is non-limiting and is presented for example only. FIG. 1 illustrates an example wireless system 100 in accordance with an example embodiment of the invention. The example wireless system 100 comprises three WCDMA Node Bs, NBs, 101, 103 and 105, each communicating with a user equipment, UE, 102, 104 and 106, respectively. Although three NBs and just one UE for each NB are shown in FIG. 1, the example wireless system 100 may comprise more or less NBs and more UEs for each NB.

The random access channel, RACH, is an uplink, UL, transport channel sent from the UEs 102, 104 and 106 to NBs 101, 103 and 105, respectively. The RACH is characterized by a collision risk and by being transmitted using open loop power control. It is typically used for signalling purposes, to register the terminal after power-on to the network or to perform location update after moving from one location area to another or to initiate a call. In physical layer, RACH is mapped to physical random access channel, PRACH. During a RACH procedure, a UE transmits a RACH message in assigned access slots. Preambles of much shorter duration are transmitted before the RACH message.

In an example embodiment, the network communicates to the UE the RACH parameters including the preamble power ramping step size P₀ and the (maximum) number n of preambles. With that information, the UE is able to calculate the power levels of the preambles as PA(1), PA(2), . . . , PA(n) in increasing order.

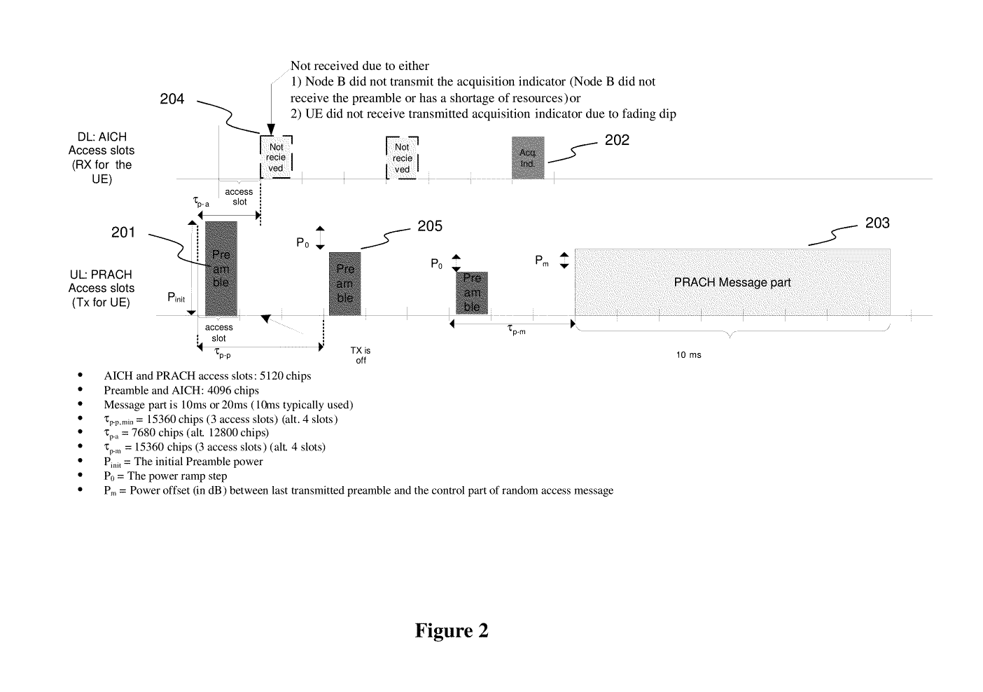

FIG. 2 illustrates an RACH operation in accordance with an example embodiment of the invention. In the example of FIG. 2, a UE, such as for example, the UE 102, 104 or 106 of FIG. 1, may start transmitting at 201 a PRACH preamble in uplink with an initial power level Pᵢₙᵢₜ higher than the lowest power PA(1), e.g. the highest power PA(n). After successfully receiving a PRACH preamble, a network element, such as for example, the NB 101, 103, or 105 of FIG. 1, may transmit an acknowledgement indicator, ACK, 202 in a downlink, DL, channel. The ACK can be such as for example, an acquisition indicator carried in the acquisition indicator channel, AICH, in WCDMA, which informs the UE about the channel assignment that the UE can use to communicate with the NB. This channel assignment occurs as a result of a successful random access service request from the UE. In response to the acquisition indicator, the UE may send the PRACH message part 203 and the RACH access procedure is completed and ends. The PRACH message part is normally transmitted with a power offset Pₘ with respect to the one used for the last transmitted preamble. If after transmitting the PRACH preamble the UE does not receive the acquisition indicator in a predetermined time, for example, at 204, it ramps down the power by one preamble power ramping step P₀ and sends the next preamble at 205 with that modified power setting. In an example embodiment, the acquisition indicator is not received due to the fact that the NB did not transmit it because the NB either did not receive the PRACH preamble, or has s shortage of resources. In another example embodiment, when the communication channel encounters a fading dip, it is also possible that the acquisition indicator can not be received. In an example embodiment, the NB may send a negative-acknowledgement, NACK, indicator showing that the NB either did not receive the PRACH preamble successfully, or has s shortage of resources. The UE can act accordingly in a similar way as it detects no acquisition indicator.

In an example embodiment, the “ramping down and retry preamble transmission” loop would be repeated a number of times, the number being between 2 and a higher figure, e.g. maximum number of preambles as broadcast by network, or a somewhat smaller figure if maximum RACH procedure duration is desired to be shorter. If no acquisition indicator or a similar ACK indicator would be received for any of the attempts, the RACH procedure would be aborted.

It is noted that if the initial preamble power is other than the highest power PA(n), the UE would not send preambles at the highest power estimated by the network and RACH success rate might be lower.

In an example embodiment, the example procedure of FIG. 2 may also be optionally supported by modified network behaviour. In that case, the NodeB/network would detect that the preamble power level is too high and delay the acquisition indicator or ACK response until the UE has retried RACH access with lower power.

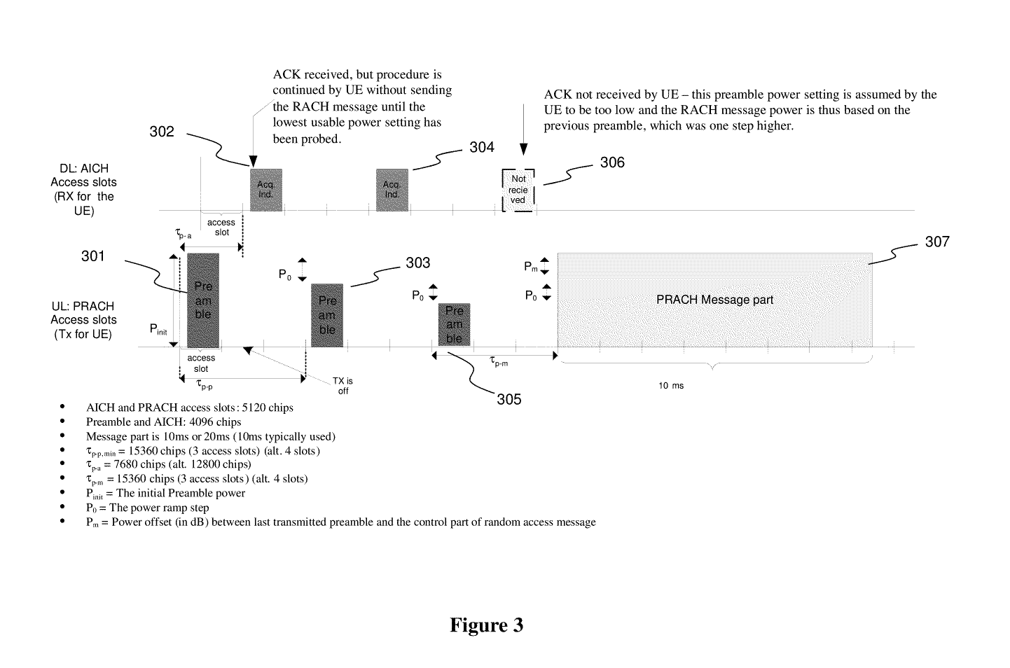

In an example embodiment, the network may support “blind” detection of the PRACH message part without prior preamble. An RACH operation under such a circumstances is described in FIG. 3.

FIG. 3 illustrates an RACH operation in accordance with an example embodiment of the invention. In the example of FIG. 3, a UE, such as for example, the UE 102, 104 or 106 of FIG. 1, may start transmitting at 301 a PRACH preamble in uplink with an initial power level Pᵢₙᵢₜ higher than the lowest power PA(1), e.g. the highest power PA(n). If the preamble with initial power level has not been detected by the NB, the RACH procedure is aborted. A new RACH procedure with new parameters may be started afterwards. If the preamble with initial power level has been detected by the Node B and ACK is received by the UE at 302, the UE has to find out the correct power level by ramping down the power level in order not to send the message with too high power. For example, if the preamble with initial power level PA(n) is acknowledged at 302, The UE sends at 303 a preamble with one preamble power ramping step lower, i.e., level PA(n-1). If the preamble with PA(n-1) is not acknowledged the UE sends a PRACH message with level derived from power level PA(n) because it is assumed that the power level PA(n-1) is too low and the previous preamble power, PA(n), is the correct one to use. If the preamble with PA(n-1) has been acknowledged at 304 the UE sends a preamble with a lower power PA(n-2) at 305. If the preamble with PA(n-2) is not acknowledged at 306 by the NodeB, the UE sends the PRACH message at 307 with power level derived from PA(n-1), and so on.

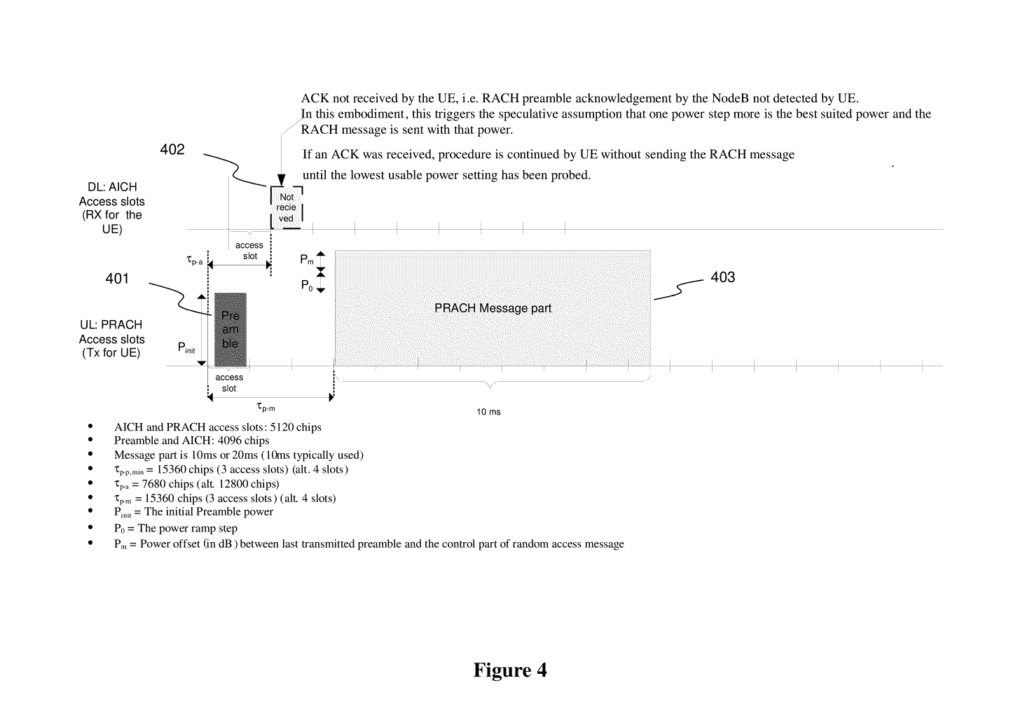

FIG. 4 illustrates an RACH operation in accordance with another example embodiment of the invention. In the example of FIG. 4, a UE, such as for example, the UE 102, 104 or 106 of FIG. 1, may start transmitting at 401 a PRACH preamble in uplink with an initial power level Pᵢₙᵢₜ higher than the lowest power PA(1) but lower than the highest power PA(n). For example, PA(n-1) may be used as the initial power. If the initial preamble has not been detected by the Node B or is not acknowledged at 402, the UE sends at 403 the PRACH message part with a power level derived from a power level one ramping step higher than the initial preamble power level, in this example, PA(n), without sending another preamble with PA(n). If the message is not received successfully, the UE will start a new RACH procedure with new parameters. If the preamble with initial power level has been detected by the Node B and is acknowledged, the UE needs to find out the correct power level by ramping down in order not to send the message with too high power. The UE sends a preamble with one preamble power ramping step lower, in this example the level PA(n-2). If the preamble with PA(n-2) is not acknowledged the UE sends a message with level derived from power level PA(n-1) because it is assumed that the power level PA(n-2) is too low and the previous preamble power, PA(n-1), is the correct one to use. If the preamble with PA(n-2) has been acknowledged the UE sends a preamble with a lower power PA(n-3). If the preamble with PA(n-3) is not acknowledged by the NodeB, the UE sends a message with power level derived from PA(n-2), and so on.

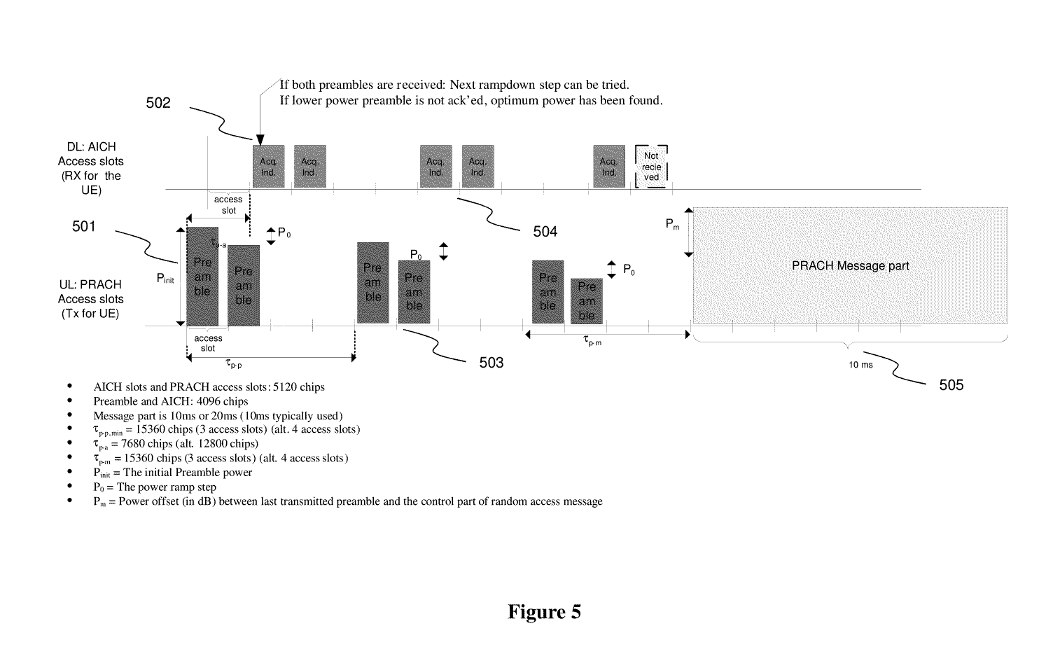

FIG. 5 illustrates an RACH operation in accordance with an example embodiment of the invention, when a better cooperation between UE and network, and the timing between RACH preamble and RACH message is desired. In the example of FIG. 5, a UE, such as for example, the UE 102, 104 or 106 of FIG. 1, may use an initial power level Pᵢₙᵢₜ higher than the lowest power PA(1) and up to the highest power PA(n), for preamble transmission at 501. In every RACH access frame, the UE uses two access slots instead of one. In each access slot, a preamble is sent. One of the two preambles within the same access frame, namely the second one in time, would be sent one power step lower than the other. The preamble with lower power is used to probe for a ACK/NACK/none response from the NodeB/network in order to check whether this preamble power level can be received by the network. The preamble with higher power (first one in time within an access frame) is used to alert the NodeB/network RACH receiver of an code and time slot where a RACH message may be sent. The UE monitors both AICH slots for a NodeB/network response at 502. If the UE receives ACKs for both preambles, it will continue to search for the correct power level by ramping down in order not to send the message with too high power. If the preamble with higher power level has been acknowledged by the Node B but the preamble with lower power level has not, the higher power level can be used to derive the power level for PRACH message part. Moreover, the parameters (e.g. signature, access slot) associated with the preamble with higher power level can be used by the UE to send the PRACH message at 505, which ends the RACH procedure.

If the UE needs to search for the correct power level by ramping down, in the next access frame 503, the UE sends again two preambles, now both with one preamble power ramping step lower power. Again, the AICH responses are checked at 504, and so on. In summary, the AICH responses are checked as follows: if acknowledgements are detected for both preambles, the UE continues ramping down; if acknowledgement is detected for higher power preamble and no acknowledgement is detected for lower power preamble, the UE sends PRACH message with power setting based on the higher power preamble; if acknowledgement is detected for lower power preamble and no acknowledgement is detected for higher power preamble, the UE may transmit the two preambles again with current power levels. This is probably a rare case but may occur due to resource shortage; and if no acknowledgement is detected for both preambles, the RACH procedure is aborted.

Due to timing requirements in the 3GPP specification, interworking with standard-compliant networks might imply parameter restrictions, e.g. the preamble-to-preamble distance might need to be set to four and the two access slots to be used might have to be adjacent. Availability of adjacent access slots requires suitable network configuration and signalling with regard to RACH access groups, which define access slots available to the UE. According to 3GPP TS 25.211, which is entirely incorporated herein by reference, the last 1024 chips of the AICH are not transmitted, thus the UE does not need to receive those. Similarly, the preamble does not occupy the full access slot, but only 4096 chips. For further timing constraint relief, partial (i.e. truncated) preamble transmission and AICH reception could be used, as these signals are repetitions of the same content with some coding gain headroom.

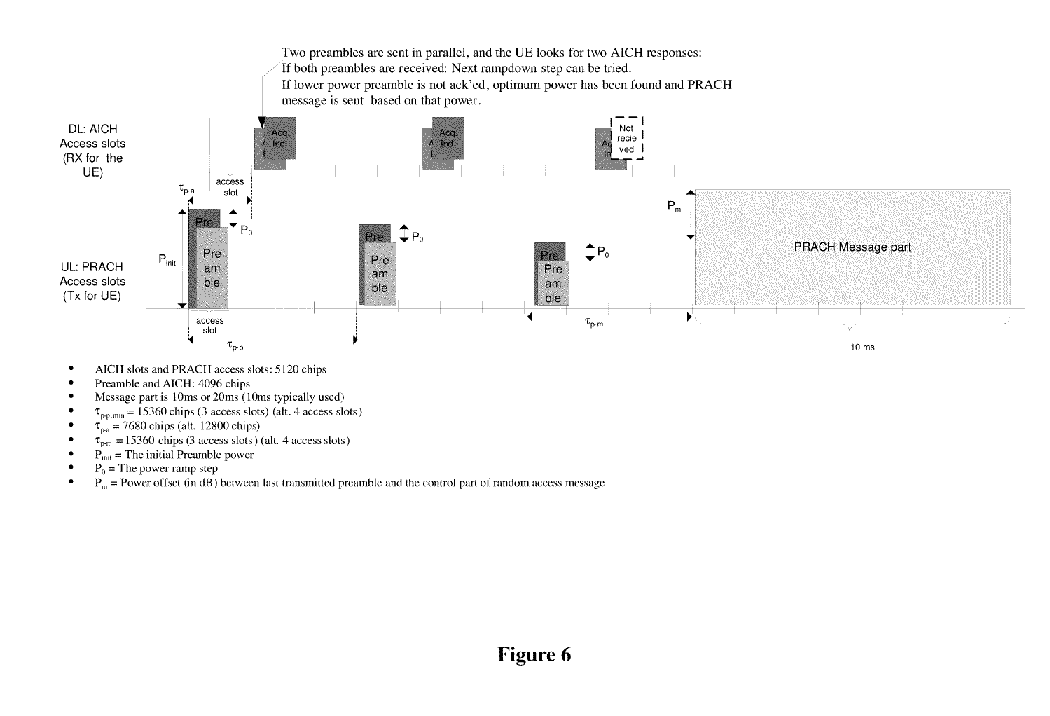

Instead of sending the two preambles in a serial manner one-after-the-other, they could be sent in parallel, i.e. at the same time and in the same RACH access slot. FIG. 6 illustrates such an RACH operation in accordance with an example embodiment of the invention. Other than changing from serial to parallel transmission, the example embodiment of FIG. 6 would operate similarly to the one described in FIG. 5 in that between the two preambles, the lower-power preamble assists in probing for the lowest feasible transmission power, while the higher-power preamble prepares a NodeB reception slot with a known-good power level. With such an implementation, the network's responses on the AICH would be received in the same slot and the existing timing specified by the 3GPP could be used without restrictions. Different preamble signatures, mapping to different channels and spreading codes, would allow for detection and differentiation of the two different preambles in the NodeB. Similarly, the two parallel responses can be detected by the UE due to the different coding, using the benefits coming from the coding gain.

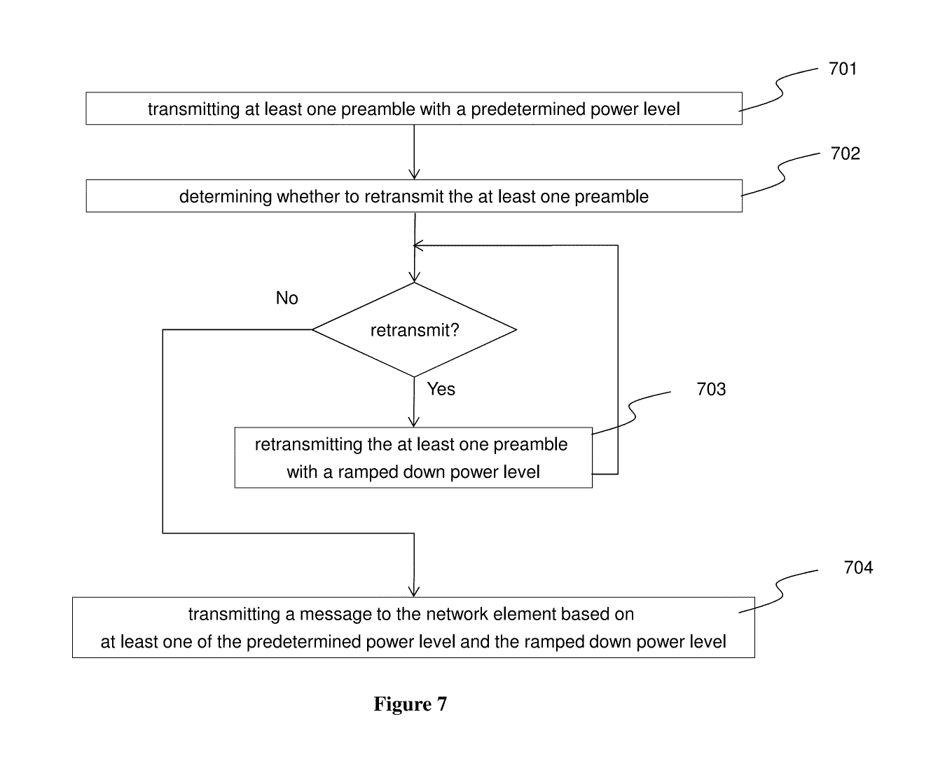

FIG. 7 illustrates a flow diagram of performing a random access procedure as described in an example embodiment. In FIG. 7, a UE, such as for example, the UE 102, 104 or 106 of FIG. 1, may transmit at 701 at least one preamble with a predetermined power level to a network element, such as for example, the NE 101, 103 and 105 of FIG. 1. At 702, the UE may determine whether to retransmit the at least one preamble to the network element. If it is determined to retransmit, the UE retransmits the at least one preamble with a ramped down power level at 703 and repeat the determination on whether to retransmit. If it is determined not to retransmit, the UE may transmit a message to the network element based on at least one of the predetermined power level and the ramped down power level at 704. It is noted that besides the power level, some other preamble parameter may also change between retransmissions, for example, the preamble signature, and so on.

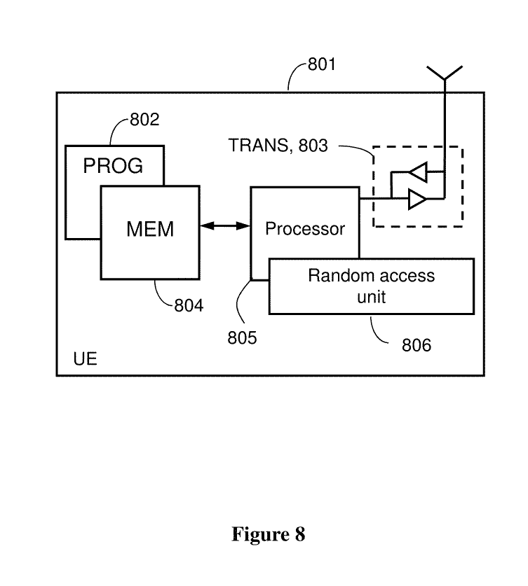

Reference is made to FIG. 8 for illustrating a simplified block diagram of an example apparatus that is suitable for use in practicing various example embodiments of this invention. In FIG. 8, a UE 801 includes at least one processor 805, at least one memory (MEM) 804 coupled to the at least one processor 805, and a suitable transceiver (TRANS) 803 (having a transmitter (TX) and a receiver (RX)) coupled to the at least one processor 805. The at least one MEM 804 stores a program (PROG) 802. The TRANS 803 is for bidirectional wireless communications with a network element, which is not shown in this figure.

As shown in FIG. 8, the UE 801 may further include a random access unit 806. The unit 806, together with the at least one processor 805 and the PROG 802, may be utilized by the UE 801 in conjunction with various example embodiments of the application, as described herein.

The PROG 802 is assumed to include program instructions that, when executed by the associated processor, enable the electronic apparatus to operate in accordance with the example embodiments of this disclosure, as discussed herein.

In general, the example embodiment of the apparatus 801 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The example embodiments of this disclosure may be implemented by computer software or computer program code executable by the processors 805, or by hardware, or by a combination of software and hardware.

The MEM 804 may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. The processor 805 may be of any type suitable to the local technical environment, and may include one or more of general purpose computers, special purpose computers, microprocessors, digital signal processors (DSPs) and processors based on multi-core processor architecture, as non-limiting examples.

Without in any way limiting the scope, interpretation, or application of the claims appearing below, a technical effect of one or more of the example embodiments disclosed herein may be resulting in the UE finding the correct power level faster (with lower number of preambles), especially if the initial preamble power is set by the network to a low value compared to the typical operation point. Depending on the embodiment, this may lead to lower total interference because of a lower number of preambles.

Embodiments of the present invention may be implemented in software, hardware, application logic or a combination of software, hardware and application logic. The software, application logic and/or hardware may reside on an apparatus such as a user equipment, a NodeB or other mobile communication devices. If desired, part of the software, application logic and/or hardware may reside on a UE 801, and part of the software, application logic and/or hardware may reside on other chipset or integrated circuit. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

Further, the various names used for the described parameters are not intended to be limiting in any respect, as these parameters may be identified by any suitable names.

If desired, the different functions discussed herein may be performed in a different order and/or concurrently with each other. Furthermore, if desired, one or more of the above-described functions may be optional or may be combined. As such, the foregoing description should be considered as merely illustrative of the principles, teachings and example embodiments of this invention, and not in limitation thereof.

What is claimed is:

1. A method for performing a random access procedure, comprising:
transmitting at least one preamble with a predetermined power level to a network element;
determining whether to retransmit the at least one preamble to the network element;
if it is determined to retransmit, retransmitting the at least one preamble with a ramped down power level; and
transmitting a message to the network element based on at least one of the predetermined power level and the ramped down power level.

2. The method of claim 1, wherein:
determining whether to retransmit the at least one preamble comprising
detecting whether an acknowledgement indicator is received from the network element; and
if the acknowledgement indicator is not received, determining to retransmit the at least one preamble;
and wherein transmitting the message to the network element comprising
transmitting the message based on the last preamble power level;
and the method further comprising
repeating the steps of determining and retransmitting until the acknowledgement indicator is received.

3. The method of claim 1, wherein:
determining whether to retransmit the at least one preamble comprising
detecting whether an acknowledgement indicator is received from the network element;
if the acknowledgement indicator is not received for the initial preamble, aborting the random access procedure; and
if the acknowledgement indicator is received, determining to retransmit the at least one preamble;
and wherein transmitting the message to the network element comprising
transmitting the message based on a power level that is one preamble power ramping step higher than the last preamble power level;
and the method further comprising
repeating the steps of determining and retransmitting until the acknowledgement indicator is not received.

4. The method of claim 1, wherein:
determining whether to retransmit the at least one preamble comprising
detecting whether an acknowledgement indicator is received from the network element; and
if the acknowledgement indicator is received, determining to retransmit the at least one preamble;
and wherein transmitting the message to the network element comprising
transmitting the message based on a power level that is one preamble power ramping step higher than the last preamble power level;
and the method further comprising
repeating the steps of determining and retransmitting until the acknowledgement indicator is not received.

5. The method of claim 4, wherein the predetermined power level is less than a maximum allowed power level.

6. The method of claim 1, wherein:
transmitting at least one preamble with a predetermined power level comprising
transmitting at least two preambles with different predetermined power levels;
wherein determining whether to retransmit the at least one preamble comprising
detecting whether at least two acknowledgement indicators are received from the network element;
if none of the acknowledgement indicators is received, aborting the random access procedure;
if all the acknowledgement indicators are received, determining to retransmit the at least two preambles with respective ramped down power levels; and
if the acknowledgement indicator for the preamble with higher power level is not received but the acknowledgement indicator for the preamble with lower power level is received,
determining to retransmit the at least two preambles with current power levels;
and wherein transmitting the message to the network element comprising
transmitting the message based on the last higher preamble power level;
and the method further comprising
repeating the steps of determining and retransmitting until the acknowledgement indicator for the preamble with higher power level is received but the acknowledgement indicator for the preamble with lower power level is not received.

7. The method of claim 6, wherein the at least two preambles are transmitted in either a serial or a parallel manner.

8. The method of claim 1, wherein the power level is ramped down with a predetermined step.

9. An apparatus for performing a random access procedure comprising:
at least one processor, and at least one memory including computer program code, wherein the at least one memory and the computer program code configured to, with the at least one processor, cause the apparatus at least to:
transmit at least one preamble with a predetermined power level to a network element;
determine whether to retransmit the at least one preamble to the network element;
if it is determined to retransmit, retransmit the at least one preamble with a ramped down power level; and
transmit a message to the network element based on at least one of the predetermined power level and the ramped down power level.

10. The apparatus of claim 9, wherein:
whether to retransmit the at least one preamble is determined by
detecting whether an acknowledgement indicator is received from the network element; and
if the acknowledgement indicator is not received, determining to retransmit the at least one preamble;
and wherein the message is transmitted to the network element by
transmitting the message based on the last preamble power level;
and wherein the at least one memory and the computer program code configured to, with the at least one processor, cause the apparatus further to
repeat the steps of determining and retransmitting until the acknowledgement indicator is received.

11. The apparatus of claim 9, wherein:
whether to retransmit the at least one preamble is determined by
detecting whether an acknowledgement indicator is received from the network element;
if the acknowledgement indicator is not received for the initial preamble, aborting the random access procedure; and
if the acknowledgement indicator is received, determining to retransmit the at least one preamble;
and wherein the message is transmitted to the network element by
transmitting the message based on a power level that is one preamble power ramping step higher than the last preamble power level;
and wherein the at least one memory and the computer program code configured to, with the at least one processor, cause the apparatus further to
repeat the steps of determining and retransmitting until the acknowledgement indicator is not received.

12. The apparatus of claim 9, wherein:
whether to retransmit the at least one preamble is determined by
detecting whether an acknowledgement indicator is received from the network element; and
if the acknowledgement indicator is received, determining to retransmit the at least one preamble;
and wherein the message is transmitted to the network element by
transmitting the message based on a power level that is one preamble power ramping step higher than the last preamble power level;
and wherein the at least one memory and the computer program code configured to, with the at least one processor, cause the apparatus further to
repeat the steps of determining and retransmitting until the acknowledgement indicator is not received.

13. The apparatus of claim 12, wherein the predetermined power level is less than a maximum allowed power level.

14. The apparatus of claim 9, wherein:
at least one preamble with a predetermined power level is transmitted by
transmitting at least two preambles with different predetermined power levels;
and wherein whether to retransmit the at least one preamble is determined by
detecting whether at least two acknowledgement indicators are received from the network element; and
if none of the acknowledgement indicators is received, aborting the random access procedure;
if all the acknowledgement indicators are received, determining to retransmit the at least two preambles with respective ramped down power levels; and
if the acknowledgement indicator for the preamble with higher power level is not received but the acknowledgement indicator for the preamble with lower power level is received,
determining to retransmit the at least two preambles with current power levels;
and wherein the message is transmitted to the network element by
transmitting the message based on the last higher preamble power level;
and wherein the at least one memory and the computer program code configured to, with the at least one processor, cause the apparatus further to
repeat the steps of determining and retransmitting until the acknowledgement indicator for the preamble with higher power level is received but the acknowledgement indicator for the preamble with lower power level is not received.

15. A computer program product for performing a random access procedure comprising a computer-readable medium bearing computer program code embodied therein for use with a computer, the computer program code includes code for:
transmitting at least one preamble with a predetermined power level to a network element;
determining whether to retransmit the at least one preamble to the network element;
if it is determined to retransmit, retransmitting the at least one preamble with a ramped down power level; and
transmitting a message to the network element based on at least one of the predetermined power level and the ramped down power level.

16. The computer program product of claim 15, wherein:
the code for determining whether to retransmit the at least one preamble comprising
code for detecting whether an acknowledgement indicator is received from the network element; and
code for if the acknowledgement indicator is not received, determining to retransmit the at least one preamble;
and wherein the code for transmitting the message to the network element comprising
code for transmitting the message based on the last preamble power level;
and wherein the computer program code further includes
code for repeating the steps of determining and retransmitting until the acknowledgement indicator is received.

17. The computer program product of claim 15, wherein:
the code for determining whether to retransmit the at least one preamble comprising
code for detecting whether an acknowledgement indicator is received from the network element;
code for if the acknowledgement indicator is not received for the initial preamble, aborting the random access procedure; and
code for if the acknowledgement indicator is received, determining to retransmit the at least one preamble;
and wherein the code for transmitting the message to the network element comprising
code for transmitting the message based on a power level that is one preamble power ramping step higher than the last preamble power level;
and wherein the computer program code further includes
code for repeating the steps of determining and retransmitting until the acknowledgement indicator is not received.

18. The computer program product of claim 15, wherein:
the code for determining whether to retransmit the at least one preamble comprising
code for detecting whether an acknowledgement indicator is received from the network element; and
code for if the acknowledgement indicator is received, determining to retransmit the at least one preamble;
and wherein the code for transmitting the message to the network element comprising
code for transmitting the message based on a power level that is one preamble power ramping step higher than the last preamble power level;
and wherein the computer program code further includes
code for repeating the steps of determining and retransmitting until the acknowledgement indicator is not received.

19. The computer program product of claim 18, wherein the predetermined power level is less than a maximum allowed power level.

20. The computer program product of claim 15, wherein:
the code for transmitting at least one preamble with a predetermined power level comprising
code for transmitting at least two preambles with different predetermined power levels;
and wherein the code for determining whether to retransmit the at least one preamble comprising
code for detecting whether at least two acknowledgement indicators are received from the network element; and
code for if none of the acknowledgement indicators is received, aborting the random access procedure;
if all the acknowledgement indicators are received, determining to retransmit the at least two preambles with respective ramped down power levels; and
if the acknowledgement indicator for the preamble with higher power level is not received but the acknowledgement indicator for the preamble with lower power level is received,
determining to retransmit the at least two preambles with current power levels;
and wherein the code for transmitting the message to the network element comprising
code for transmitting the message based on the last higher preamble power level;
and wherein the computer program code further includes
code for repeating the steps of determining and retransmitting until the acknowledgement indicator for the preamble with higher power level is received but the acknowledgement indicator for the preamble with lower power level is not received.
